(19) United States
(12) Patent Application Publication
(10) Pub. No.: US 2009/0070325 A1
(43) Pub. Date: Mar. 12, 2009

(54) Identifying Information Related to a Particular Entity from Electronic Sources

(76) Inventors: Raefer Christopher Gabriel, New York, NY (US); Michael Benjamin Fertik, Palo Alto, CA (US); Owen Wheble Tripp, Menlo Park, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/209,169

(22) Filed: Sep. 11, 2008

Related U.S. Application Data
(60) Provisional application No. 60/971,858, filed on Sep. 12, 2007.

(51) Int. Cl. G06F 17/30

(52) U.S. Cl. 707/5; 707/E17.046

(57) ABSTRACT

Presented are systems, apparatuses, articles of manufacture, and methods for identifying information about a particular entity including receiving electronic documents selected based on one or more search terms from a plurality of terms related to the particular entity, determining one or more feature vectors for each received electronic document, where each feature vector is determined based on the associated electronic document, clustering the received electronic documents into a first set of clusters of documents based on the similarity among the determined feature vectors, and determining a rank for each cluster of documents in the first set of clusters of documents based on one or more ranking terms from the plurality of terms related to the particular entity, where the one or more ranking terms contain at least one term from the plurality of terms for the particular entity that is not in the one or more search terms.

### RELATED APPLICATIONS

This application claims the benefit of priority to U.S. Provisional Application No. 60/971,858, filed Sep. 12, 2007, titled “Identifying Information Related to a Particular Entity from Electronic Sources,” which is herein incorporated by reference in its entirety.

### FIELD OF THE DISCLOSURE

The presently-claimed invention relates to methods, systems, articles of manufacture, and apparatuses for searching electronic sources, and, more particularly to identifying information related to a particular entity from electronic sources.

### BACKGROUND

Since the early 1990's, the number of people using the World Wide Web and the Internet has grown at a substantial rate. As more users take advantage of the services available on the Internet by registering on websites, posting comments and information electronically, or simply interacting with companies that post information about others (such as online newspapers), more and more information about the users is available. There is also a substantial amount of information available in publicly and privately available databases, such as LexisNexis™. When searching one of these databases using the name of a person or entity and other identifying information, there can be many “false positives” because of the existence of other people or entities with the same name. False positives are search results that satisfy the query terms, but do not relate to the intended person or entity. The desired search results can also be buried or obfuscated by the abundance of false positives.

In order to reduce the number of false positives, one may add additional search terms from known or learned biographical, geographical, and personal terms for the particular person or other entity. This will reduce the number of false positives received, but many relevant documents may be excluded. Therefore, there is a need for a system that allows the breadth of searches that are made on fewer terms while still determining which search results are most likely to relate to the intended individual or entity.

### SUMMARY

Presented are systems, apparatuses, articles of manufacture, and methods for identifying information about a particular entity including receiving electronic documents selected based on one or more search terms from a plurality of terms related to the particular entity, determining one or more feature vectors for each received electronic document, where each feature vector is determined based on the associated electronic document, clustering the received electronic documents into a first set of clusters of documents based on the similarity among the determined feature vectors, and determining a rank for each cluster of documents in the first set of clusters of documents based on one or more ranking terms from the plurality of terms related to the particular entity, where the one or more ranking terms contain at least one term from the plurality of terms for the particular entity that is not in the one or more search terms.

In some embodiments, the one or more feature vectors include one or more feature vectors from the group selected from a term frequency inverse document frequency vector, a proper noun vector, a metadata vector, and a personal information vector. The ranked clusters may be presented to the particular entity.

In some embodiments, the systems, apparatuses, articles of manufacture, and methods also include reviewing the ranked clusters, modifying the ranking of the clusters, and presenting the modified ranking of the clusters to the particular entity. Modifying the ranking of the clusters may include removing one or more clusters from the results.

In some embodiments, the systems, apparatuses, articles of manufacture, and methods also include determining a second set of one or more search terms based on one or more features in the determined feature vectors of one or more received electronic documents, receiving a second set of electronic documents selected based on the second set of one or search terms, determining a second set of one or more feature vectors for each electronic document in the second set of electronic documents, where each feature vector is determined based on the associated electronic document, clustering the second set of received electronic documents into a second set of clusters of documents based on the similarity among the second set of one or more feature vectors, and determining a rank for each cluster of documents in the first set of clusters of documents and the second set of clustered documents based on the one or more ranking terms from the plurality of terms related to the particular entity, where the one or more ranking terms contains at least one term from the plurality of terms for the particular entity that is not in the second set of one or more search terms. The second set of one or more search terms may be determined based on the frequency of occurrence of those features in the one or more feature vectors that do not have a corresponding term in the plurality of terms related to the particular entity.

In some embodiments, the systems, apparatuses, articles of manufacture, and methods also include submitting a query to an electronic information module, where the query is determined based on the one or more search terms, and receiving the electronic documents includes receiving a response to the query from the electronic information module.

In some embodiments, the systems, apparatuses, articles of manufacture, and methods also include receiving a set of electronic documents, where the set of electronic documents are selected based on a first set of one or more search terms from the plurality of terms related to the particular entity, if the set of electronic documents contains more than a threshold number of electronic documents, then determining the one or more search terms used in the receiving step as the first set of one or more search terms combined with a second set of one or more search terms from the plurality of terms related to the particular entity, where the search terms in the second set of one or more search terms and the search terms in the first set of one or more search terms do not overlap, and if the set of electronic documents contains no more than the threshold number of electronic documents, then the step of receiving the electronic documents includes receiving the set of electronic documents.

In some embodiments, the systems, apparatuses, articles of manufacture, and methods also include receiving a set of electronic documents, where the set of electronic documents are selected based on a first set of one or more search terms from the plurality of terms related to the particular entity, determining a count of direct pages in the set of electronic documents, if the set of electronic documents contains more than a threshold count of direct pages, then determining the one or more search terms used in the receiving step as the first set of one or more search terms in combination with a second set of one or more search terms from the plurality of terms related to the particular entity, where the features in the second set of one or more search terms and the features in the first set of one or more search terms do not overlap, and if the set of electronic documents contains no more than the threshold count of direct pages, then the step of receiving the electronic documents includes receiving the set of electronic documents.

In some embodiments, clustering the received electronic documents includes (a) creating initial clusters of documents, (b) for each cluster of documents, determining the similarity of the feature vectors of the documents within each cluster with those in each other cluster, (c) determining a highest similarity measure among all of the clusters, and (d) if the highest similarity measure is at least a threshold value, combining the two clusters with the highest determined similarity measure. The clustering the received electronic documents may further include repeating steps (b), (c), and (d) until the highest similarity measure among the clusters is below the threshold value.

In some embodiments, the similarity of the feature vectors of a document is calculated based on a normalized dot product of the feature vectors and/or determining the rank for each cluster of documents includes assigning a higher rank to those clusters of documents that contain documents that have a higher similarity measure with the one or more ranking terms.

### BRIEF DESCRIPTION OF THE DRAWINGS

The accompanying drawings, which are incorporated in and constitute a part of this specification, illustrate exemplary embodiments and together with the description, serve to explain the principles of the claimed inventions. In the drawings:

FIG. 1 is a block diagram depicting an exemplary system for identifying information related to a particular entity.

FIG. 2 is a flowchart that depicts a method for identifying information related to a particular entity.

FIG. 3 is a flowchart depicting a method for querying.

FIG. 4 is a flowchart depicting a method of selecting a query.

FIG. 5 is a block diagram providing an exemplary embodiment illustrating feature vector grouping.

FIG. 6 is a block diagram providing an exemplary embodiment illustrating feature vector extraction.

FIG. 7 is a flowchart depicting the creation of electronic documents clusters.

FIG. 8 is a flowchart depicting another method for identifying information related to a particular entity.

### DESCRIPTION OF THE EMBODIMENTS

Reference will now be made in detail to the present exemplary embodiments of the claimed inventions, examples of which are illustrated in the accompanying drawings. Wherever possible, the same reference numbers will be used throughout the drawings to refer to the same or like parts.

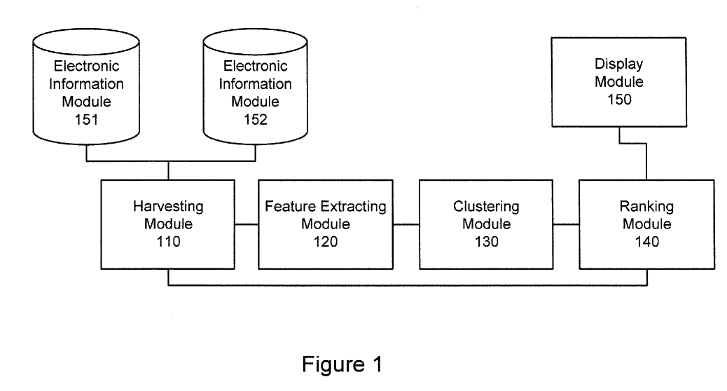

FIG. 1 is a block diagram depicting an exemplary system for identifying information related to a particular entity. In the exemplary system, harvesting module 110 is coupled to feature extracting module 120, ranking module 140, and two or more electronic information modules 151 and 152. Harvesting module 110 receives electronic information related to a particular entity from electronic information modules 151 and 152. Electronic information modules 151 and 152 may include a private information database, such as Lexis Nexis™, or a publicly available source for information, such as the Internet, obtained, for example, via a Google™ or Yahoo™ search engine. Electronic information modules 151 and 152 may also include private party websites, company websites, cached information stored in a search database, or “blogs” or websites, such as social networking websites or news agency websites. In some embodiments, electronic information module 151 and 152 may also collect and index electronic source documents. In these embodiments, the electronic information modules 151 and 152 may be called or include metasearch engines. The electronic information received may relate to a person, organization, or other entity. The electronic information received at harvesting module 110 may include web pages, Microsoft word documents, plain text files, encoded documents, structured data, or any other appropriate form of electronic information. In some embodiments, harvesting module 110 may obtain the electronic information by sending a query to one or more query processing engines (not pictured) associated with the electronic information modules 151 and 152. In some embodiments, electronic information modules 151 and/or 152 may include one or more query processing engines or metasearch engines and harvesting module 110 may send queries to electronic information module 151 and/or 152 for processing. Such a query may be constructed based on identifying information about the particular entity. In some embodiments, harvesting module 110 may receive electronic information from electronic information modules 151 and 152 based on queries or instructions sent from other devices or modules.

In addition to being coupled to harvesting module 110, feature extracting module 120 may be coupled to clustering module 130. Feature extracting module 120 may receive harvested electronic information from harvesting module 110. In some embodiments, the harvested information may include the electronic documents themselves, the universal resource locators (URLs) of the documents, metadata from the electronic documents, and any other information received in or about the electronic information. Feature extracting module 120 may create one or more feature vectors based on the information received. The creation and use of the feature vectors is discussed more below.

Clustering module 130 may be coupled to feature extracting module 120 and ranking module 140. Clustering module 130 may receive the feature vectors, electronic documents, metadata, and/or other information from feature extracting module 120. Clustering module 130 may create multiple clusters, which each contain information related to one or more documents. In some embodiments, clustering module 130 may initially create one cluster for each electronic document. Clustering module 130 may then combine similar clusters, thereby reducing the number of clusters. Clustering module 130 may stop clustering once there are no longer clusters that are sufficiently similar. There may be one or more clusters remaining when clustering stops. Various embodiments of clustering are discussed in more detail below.

In FIG. 1, ranking module 140 is coupled to clustering module 130, display module 150, and harvesting module 110. Ranking module 140 may receive clusters of electronic information from clustering module 130. Ranking module 140 ranks the clusters of documents or electronic information. Ranking module 140 may perform this ranking by comparing the documents and other electronic information in each cluster to information known about the particular individual or entity. In some embodiments, feature extraction module 120 may be coupled with ranking module 140. Ranking is discussed in more detail below.

Display module 150 may be coupled to ranking module 140. Display module 150 may include an Internet web server, such as Apache Tomcat™, Microsoft's Internet Information Services™, or Sun's Java System Web Server™. Display module 150 may also include a proprietary program designed to allow an individual or entity to view results from ranking module 140. In some embodiments, display module 150 receives ranking and cluster information from ranking module 140 and displays this information or information created based on the clustering and ranking information. As described below, this information may be displayed to the entity about which the information pertains, to a human operator who may modify, correct, or alter the information, or to any other system or agent capable of interacting with the information, including an artificial intelligence system or agent (AI agent).

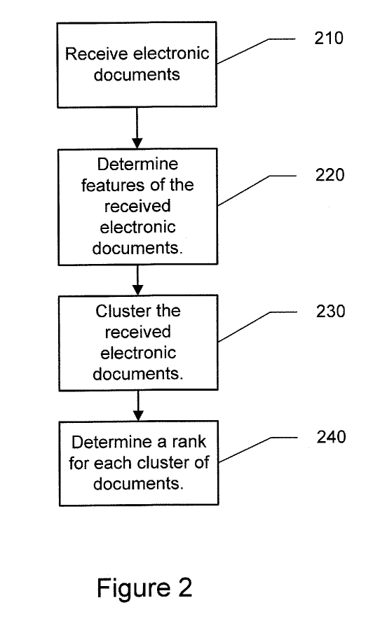

FIG. 2 is a flowchart that depicts a method for identifying information related to a particular entity. In step 210, electronic documents or other electronic information is received. In some embodiments, electronic documents may be received from electronic information modules 151 and 152 at harvesting module 110, as shown in FIG. 1. The electronic documents and other electronic information may be received based on a query sent to a query processing engine associated with or contained within electronic information modules 151 and/or 152.

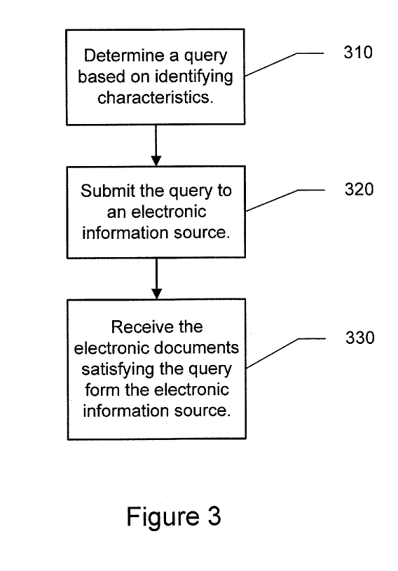

Step 210 may include the steps depicted in FIG. 3, which is a flowchart depicting a method for querying. In step 310, a query is created based on search terms related to the particular entity for which information is sought. The search terms may include, for example, first name, last name, place of birth, city of residence, schools attended, current and past employment, associational membership, titles, hobbies, and any other appropriate biographical, geographical, or other information. The query determined in step 310 may include any appropriate subset of the search terms. For example, the query may include the entity name (e.g., the first and last name of a person or the full name of a company), and/or one or more other biographical, geographical, or other terms about the entity.

In some embodiments, the search terms used in the query in step 310 may be determined by first searching, in a publicly available database or search engine, a private search engine, or any other appropriate electronic information module 151 or 152, on the user's name or other search terms, looking for the most frequently occurring phrases or terms in the result set, and presenting these phrases and terms to the user. The user may then select which of the resultant phrases and terms to use in constructing the query in step 310.

In step 320, the query is submitted to electronic information module 151 or 152, see FIG. 1, or a query processing engine connected thereto. The query may be submitted as Hypertext Transfer Protocol (HTTP) POST or GET mechanism, hypertext markup language (HTML), extensible markup language (XML), structured query language (SQL), plain text, Google Base, as terms structured with Boolean operators, or in any appropriate format using any appropriate query or natural language interface. The query may be submitted via the Internet, an intranet, or via any other appropriate coupling to a query processing engine associated with or contained within electronic information modules 151 and/or 152.

After the query has been submitted in step 320, the results for the query are received as shown in step 330. In some embodiments, these query results may be received by harvesting module 110 or any appropriate module or device. As noted above, in various embodiments, the query results may be received as a list of search results, the list formatted in plain text, HTML, XML, or any other appropriate format. The list may refer to electronic documents, such as web pages, Microsoft word documents, videos, portable document format (PDF) documents, plain text files, encoded documents, structured data, or any other appropriate form of electronic information or portions thereof. The query results may also directly include web pages, Microsoft word documents, videos, PDF documents, plain text files, encoded documents, structured data, or any other appropriate form of electronic information or portions thereof. The query results may be received via the Internet, an intranet, or via any other appropriate coupling.

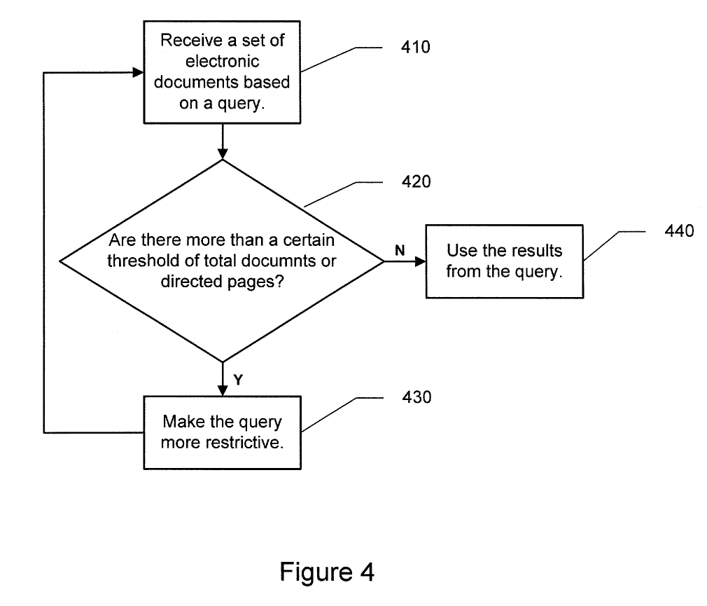

Returning now to FIG. 2, step 210 may also include the steps shown in FIG. 4, which is a flowchart depicting a method of selecting a query. After a set of query results is received in step 410, then, in step 420, a check is made to determine whether there are more than a certain threshold of electronic documents in the query results. In some embodiments, the check in step 420 may be made in order to determine whether there is more than a certain threshold of total documents. The threshold set for total documents depends on the embodiment, but may be in the range of hundreds to thousands of documents.

In some embodiments, the check in step 420 may be made to determine whether there are more than a certain threshold percentage of “direct pages.” Direct pages may be those electronic documents that appear to be directed to a particular individual or entity. Some embodiments may determine which electronic documents are direct pages by reviewing the contents of the documents. For example, if an electronic document includes multiple instances of the individual's or entity's name and/or the electronic document includes relevant title, address, or email, then it may be flagged as a direct page. The threshold percentage for the number of direct pages may be any appropriate number and may be in the range of five percent to fifteen percent.

In some embodiments, a metric other than total pages or number of direct pages may be used in step 420 to determine whether to refine the search. For example, in step 420, the number of documents that have a particular characteristic can be compared to an appropriate threshold. In some embodiments, that characteristic may be, for example, the number of times that the individual or entity name appears, the number of times that an image tagged with the person's name appears, the number of times a particular URL appears, or any other appropriate characteristic.

If there are more than the threshold number of relevant electronic documents as measured in step 420, then, in step 430, the query being used for the search is made more restrictive. For example, if the original query used only the individual or entity name, then the query may be restricted by adding other biographical information, such as city of birth, current employer, alma mater, or any other appropriate term or terms. What terms to add may be determined manually by a human agent, or performed automatically by randomly selecting additional search terms from a list of identifying characteristics or by selecting additional terms from a list of identifying characteristics in a predefined order, or in some embodiments, performed using artificial intelligence based learning. The more restrictive query may then be used to receive another set of electronic documents in step 410.

If no more than the certain threshold of documents is received based on the query as measured in step 420, then in step 440, the query results may be used as appropriate in steps depicted in FIGS. 2, 3, 4, 5, 6, 7, and 8.

Returning now to the discussion of FIG. 2, step 210 may include collecting results from more than one query. For example, step 210 may include collecting data on a first subset of possible search terms (e.g., an individual's full name and title), a second set of search terms (e.g., the individual's full name and alma matter), and a third set of search terms (e.g., the individual's last name, alma matter, and current employer). The additional queries may be derived based on the identifying characteristics and other query terms. In some embodiments, the additional queries may also be derived based on the additional query terms that are extracted from the clusters in step 240 (discussed below). The electronic documents associated with each of the one or more queries may be used separately or in combination.

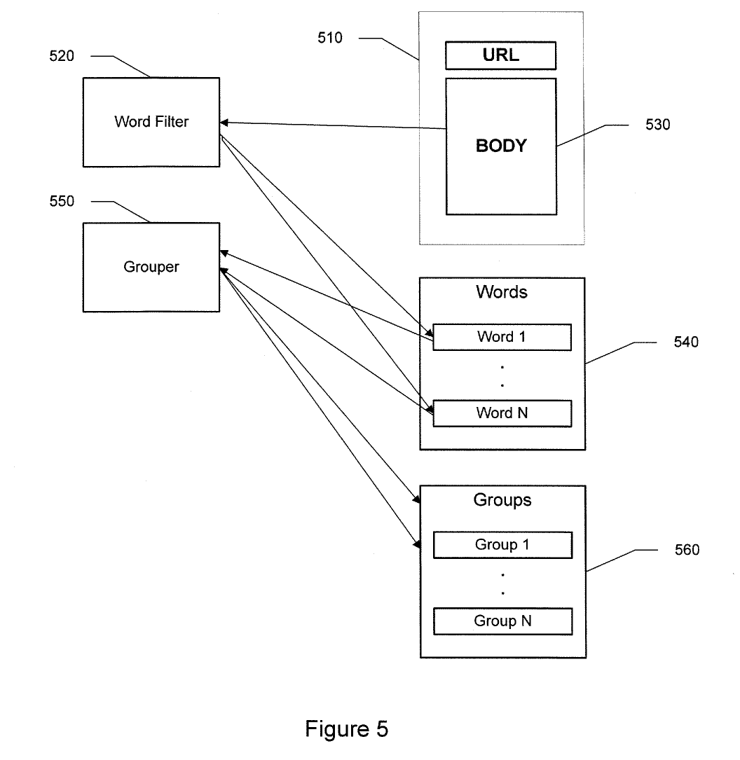

In step 220, features of the received electronic documents are determined. The features of an electronic document may be determined by feature extracting module 120 or any other appropriate module, device, or apparatus. The features of the electronic documents may be codified as feature vectors or other appropriate categorization. FIG. 5 depicts grouping or categorization of feature vectors from a web page 510. A word filter 520 can be used to extract words from the body of a web page 530. Word filter 520 determines a list of words 540 contained in the body of a web page 530. A grouper 550 then groups the list of words 540 based on similarity of other criteria to produce a set of feature vectors 560. In some embodiments, a term frequency inverse document frequency (TFIDF) vector may be determined for each document. A TFIDF vector may be formed by determining the number of occurrences of each term in each electronic document and dividing the document-centric number of occurrences by the sum of the number of times the same term occurs in all documents in the result set. In some embodiments, each feature vector includes a series of frequencies or weightings extracted from the document based on the TFIDF metric (from Salton and McGill 1983).

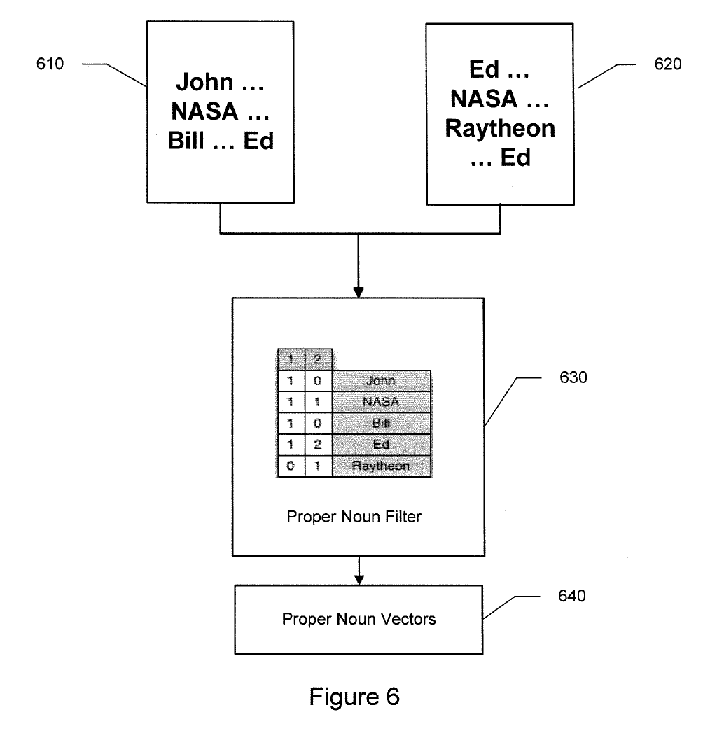

In some embodiments, step 220 may include producing feature vectors based on proper noun counts as shown in FIG. 6. The resulting vectors may be called proper noun vectors 640. The proper noun vectors 640 are determined using a proper noun filter 630 to first extract proper nouns from at least two documents 610 and 620 and then determine a vector value based on the counts of proper nouns extracted for each document 610 and 620. In some embodiments, the vector value may be the count or the ratio of counts of proper nouns in a document to the count of times that the proper noun has appeared in all the documents in the result set. In some embodiments, to determine which tokens or words in a document are proper nouns, one may use a software extractor such as Baseline Information Extraction (Balie), available at http://balie.sourceforge.net, which is a system for multi-lingual textual information extraction. In some embodiments, additional methods of detecting or estimating which tokens are proper nouns may also be used. For example, capitalized words that are not at the beginning of sentences that are not verbs may be flagged as proper nouns. Determining whether a word is a verb may be accomplished using Balie, a lookup table, or other appropriate method. In some embodiments, systems such as Balie may be used in combination with other methods of detecting proper nouns to produce a more inclusive list of tokens that may be proper nouns.

In some embodiments, a metadata feature vector may be created in step 220. A metadata feature vector may include counts of occurrences of metadata in a document or a ratio of the occurrences of metadata in a document to the total number of occurrences of the metadata in all the documents in the result set. In some embodiments, the metadata used to create the metadata feature vector may include the URLs of the documents or the links within the documents; the top level domain of URLs of the document or the links within the documents; the directory structure of the URLs of the documents or the links within the document; HTML, XML, or other markup language tags; document titles; section or subsection titles; document author or publisher information; document creation date; or any other appropriate information.

In some embodiments, step 220 may include producing a personal information vector comprising a feature vector of biographical, geographical, or other personal information. The feature vector may be constructed as a simple count of terms in the document or as a ratio of the count of terms in the document to the count of the same term in all documents in the entire result set. The biographical, geographical, or personal information may include email addresses, phone numbers, real addresses, personal titles, or other individual or entity-oriented information.

In some embodiments, step 220 may include determining other feature vectors. These feature vectors determined may be combinations of those above or may be based on other features of the electronic documents received in step 210. The feature vectors, including those described above, may be constructed in any number of ways. For example, the feature vectors may be constructed as simple counts, as ratios of counts of terms in the document to the total number of occurrences of those terms in the entire result set, as ratios of the counts of the particular terms in the document to the total number of terms in that document, or as any other appropriate count, ratio, or other calculation.

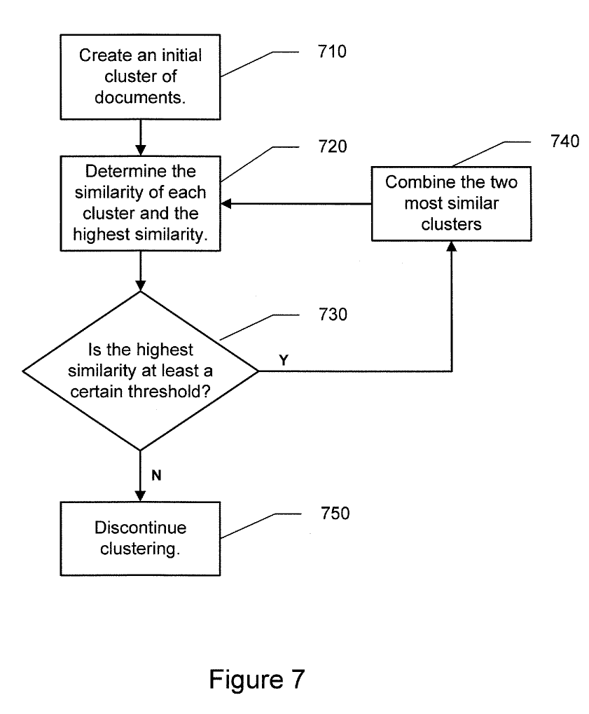

In step 230, the electronic documents received in step 210 are clustered based on the features determined in step 220. FIG. 7 is a flowchart depicting the creation of electronic documents clusters. In some embodiments, the process depicted in FIG. 7 may be used to create the clusters of electronic documents in step 230. In some embodiments, clustering may be applied to the terms, wherein term clusters are created and then may be used in step 210. In some embodiments, clustering may be applied to inter-user key words to allow for dynamic categorization based on interests or other similarities.

In step 710, an initial cluster of documents is created. In some embodiments, there may be one electronic document in each cluster or multiple similar documents in each cluster. In some embodiments, multiple documents may be placed in each cluster based on a similarity metric. Similarity metrics are described below.

In step 720, the similarity of clusters is determined. In some embodiments, the similarity of each cluster to each other cluster may be determined. The two clusters with the highest similarity may also be determined. In some embodiments, the similarity of clusters may be determined by comparing one or more features for each document in the first cluster to the same features for each document in the second cluster. Comparing the features of two documents may include comparing one or more feature vectors for the two documents. For example, referring back to FIG. 6, the similarity of two documents 610 and 620 may be determined in part based on a proper noun vector 640. The normalized dot product of the two documents' proper noun vectors may be computed in step 630, and the greater the quantity of shared proper nouns and the more often the shared proper nouns appear, the higher the dot product and the higher the similarity measure will be. If, for example, the metadata features of documents 610 and 620 are compared, then the two documents 610 and 620 share relevant metadata (e.g., top level domains in URLs in the documents and directory structures in URLs contained in the document), the higher the dot product of the two metadata feature vectors and the higher the similarity measure.

The overall similarity of two clusters may be based on the pair-wise similarity of the features vectors for each document in the first cluster as compared to the feature vectors for each document in the second cluster. For example, if two clusters each had two documents therein, then the similarity of the two clusters may be calculated based on the average similarity of each of the two documents in the first cluster paired with each of the two documents in the second cluster.

In some embodiments, the similarity of two documents may be calculated as the dot product of the feature vectors for the two documents. In some embodiments, the dot product for the feature vectors may be normalized to bring the similarity measure into the range of zero to one. The dot product or normalized dot product may be taken for like types of feature vectors for each document. For example, a dot product or a normalized dot product may be performed on the proper noun feature vectors for two documents. A dot product or normalized dot product may be performed for each type of feature vector for each pair of documents, and these may be combined to produce an overall similarity measure for the two documents. In some embodiments, each of the comparisons of feature vectors may be equally weighted or weighted differently. For example, the proper noun or personal information feature vectors may be weighted more heavily than term frequency or metadata feature vectors, or vice-versa.

In some embodiments, referring to step 730 in FIG. 7, the highest similarity measured among the pairs of clusters may be compared to a threshold. In some embodiments, the similarity metric is normalized to a value between zero and one, and the threshold may be between 0.03 and 0.05. In other embodiments, other quantizations of the similarity metric may be used and other thresholds may apply. If the highest similarity measured among clusters is above the threshold, then the two most similar clusters may be combined in step 740. In other embodiments, the top N most similar clusters may be combined in step 740. In some embodiments, combining two clusters may include associating all of the electronic documents from one cluster with the other cluster or creating a new cluster containing all of the documents from the two clusters and removing the two clusters from the space of clusters. In some embodiments, ameliorative clustering may be used, in which documents are not removed from clusters in which they are initially placed unless the documents are merged into another cluster.

After the two (or N) most similar clusters have been combined in step 740, the similarity of each pair of clusters is determined in step 720, as described above. In determining the similarity of clusters, certain calculated data may be retained in order to avoid duplicating calculations. In some embodiments, the similarity measure for a pair of documents may not change unless one of the documents changes. If neither document changes, then the similarity measure produced for the pair of documents may be reused when determining the similarity of two clusters. In some embodiments, if the documents contained in two clusters have not changed, then the similarity measure of the two clusters may not change. If the documents in a pair of clusters have not changed, then the previously-calculated similarity measure for the pair of clusters may be reused.

Returning now to step 730, if the highest similarity measure of two clusters is not above a certain threshold, then in step 750, the combining of the clusters is discontinued. In other embodiments, the clustering may be terminated if there are fewer than a certain threshold of clusters remaining, if there have been a threshold number of combinations of clusters, or if one or more of the clusters is larger than a certain threshold size.

Returning now to FIG. 2, after the clusters have been determined in step 230, then ranks are determined for each cluster of documents in step 240. In some embodiments, the rank of each cluster may be measured by comparing each of the documents in the cluster with ranking terms. Ranking terms may include biographical, geographical, and/or personal terms known to relate to the entity or individual. For example, the ranking of a cluster of documents may be based on a similarity measure calculated between the documents in the cluster and the biographical, geographical, and/or personal terms codified as a vector. The similarity measure may be calculated using a dot product or normalized dot product or any other appropriate calculation. Embodiments of similarity calculations are discussed above. In some embodiments, the more similar the cluster is to the biographical information, the higher the cluster may be ranked.

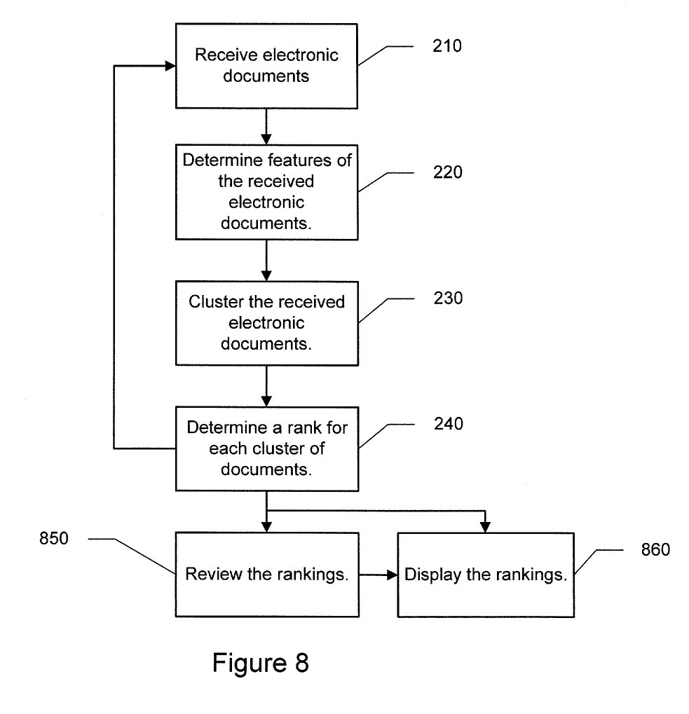

FIG. 8 is a flowchart depicting another method for identifying information related to a particular entity. Steps 210, 220, 230, and 240 of FIG. 8 are discussed above with respect to FIG. 2. In some embodiments, after steps 210, 220, 230, and 240 are performed in a manner discussed above, step 240 may additionally include determining new terms from the determined clusters. These additional query terms may be used in step 210 to query for additional electronic documents. These additional electronic documents may be processed as discussed above with respect to the flowcharts depicted in FIGS. 2-7 and here with respect to FIG. 8. In some embodiments, a human agent may select the additional terms from the ranked clusters. In some embodiments, the additional terms may be produced automatically by selecting one or more of the most frequently appearing terms from one or more of the top-ranked clusters. In some embodiments, terms may be selected by an AI agent using intelligence based learning which may include incorporating information history from prior and/or current selections.

In some embodiments, after the clusters have been ranked, the rankings may be reviewed in step 850 by a human agent or an AI agent, or presented directly to the entity or individual (in step 860). Reviewing the rankings in step 850 may result in the elimination of documents or clusters from the results. These documents or clusters may be eliminated in step 850 because they are superfluous, irrelevant, or for any other appropriate reason. The human agent or AI agent may also alter the ranking of the clusters, move documents from one cluster to another, and/or combine clusters. In some embodiments, which are not pictured, after eliminating documents or clusters, the documents remaining may be reprocessed in steps 210, 220, 230, 240, 850, and/or 860.

After documents and clusters have been reviewed in step 850, they may be presented to the entity or individual in step 860. The documents and clusters may also be presented to the entity or individual in step 860 without a human agent or AI agent first reviewing them as part of step 850. In some embodiments, the documents and clusters may be displayed to the entity or individual electronically via a proprietary interface or web browser. If documents or entire clusters were eliminated in step 850, then those eliminated documents and clusters may not be displayed to the entity or individual in step 860.

In some embodiments, the ranking in step 240 may also include using a Bayesian classifier, or any other appropriate means for generating ranking of clusters or documents within the clusters. If a Bayesian classifier is used, it may be built using a human agent's input, an AI agent's input, or a user's input. In some embodiments, to do this, the user or agent may indicate search results or clusters as either “relevant” or “irrelevant.” Each time a search result is flagged as “relevant” or “irrelevant,” tokens from that search result are added into the appropriate corpus of data (the “relevance-indicating results corpus” or the “irrelevance-indicating results corpus”). Before data has been collected for user, the Bayesian network may be seeded, for example, with terms collected from the users (such as home town, occupation, gender, etc.). Once a search result has been classified as relevance-indicating or irrelevance-indicating, the tokens (e.g. words or phrases) in the search result are added to the corresponding corpus. In some embodiments, only a portion of the search result may be added to the corresponding corpus. For example, common words or tokens, such as “a, “the,” and “and” may not be added to the corpus.

As part of maintaining the Bayesian classifier, a hash table of tokens may be generated based on the number of occurrences of each token in each corpus. Additionally, a “conditionalProb” hash table may be created for each token in either or both of the corpora to indicate the conditional probability that a search result containing that token is relevance-indicating or irrelevance-indicating. The conditional probability that a search result is relevant or irrelevant may be determined based on any appropriate calculation based on the number of occurrences of the token in the relevance-indicating and irrelevance-indicating corpora. For example, the conditional probability that a token is irrelevant to a user may be defined by the equation:

$$prob = max ( MIN\_RELEVANT \_PROB , min ( MAX\_IRRELEVANT \_PROB , irrelevatProb / total ) ) ,$$

where:
MIN_RELEVANT_PROB=0.01 (a lower threshold on relevance probability),
MAX_IRRELEVANT_PROB=0.99 (an upper threshold on relevance probability),
Let r=RELEVANT_BIAS*(the number of time the token appeared in the “relevance-indicating” corpus),
Let i=IRRELEVANT_BIAS*(the number of time the token appeared in the “irrelevance-indicating” corpus),
RELEVANT_BIAS=2.0,
IRRELEVANT_BIAS=1.0 (In some embodiments, “relevance-indicating” terms should be biased more highly than “irrelevance-indicating” terms in order to bias toward false positives and away from false negatives, which is why relevant bias may be higher than irrelevant bias),
nrel=total number of entries in the relevance-indicating corpus,
nirrel=total number of entries in the irrelevance-indicating corpus,
relevantProb=min(1.0, r/nrel),
irrelevantProb=min(1.0, i/nirrel), and
total=relevantProb+irrelevantProb.

In some embodiments, if the relevance-indicating and irrelevance-indicating corpora were seeded and a particular token was given a default conditional probability of irrelevance, then the conditional probability calculated as above may be averaged with a default value. For example, if user specified that he went to college at Harvard, the token “Harvard” may be indicated as a relevance-indicating seed and the conditional probability stored for the token Harvard may be 0.01 (only a 1% chance of irrelevance). In that case, the conditional probability calculated as above may be averaged with the default value of 0.01.

In some embodiments, if there is less than a certain threshold of entries for a particular token in either corpora or in the two corpora combined, then conditional probability that the token is irrelevance-indicating may not be calculated. Each time relevancy of search results are indicated by the user, the human agent, or the AI agent, the conditional probabilities that tokens are irrelevance-indicating may be updated based on the newly indicated search results.

The steps depicted in the flowcharts described above may be performed by harvesting module 110, feature extracting module 120, clustering module 130, ranking module 140, display module 150, electronic information module 151 or 152, or any combination thereof, by any other appropriate module, device, apparatus, or system. Further, some of the steps may be performed by one module, device, apparatus, or system and other steps may be performed by one or more other modules, devices, apparatuses, or systems. Additionally, in some embodiments, the steps of FIGS. 2, 3, 4, 5, 6, 7, and 8 may be performed in a different order and fewer or more than the steps depicted in the figures may be performed.

Coupling may include, but is not limited to, electronic connections, coaxial cables, copper wire, and fiber optics, including the wires that comprise a network. The coupling may also take the form of acoustic or light waves, such as lasers and those generated during radio-wave and infra-red data communications. Coupling may also be accomplished by communicating control information or data through one or more networks to other data devices. A network connecting one or more modules 110, 120, 130, 140, 150, 151, or 152 may include the Internet, an intranet, a local area network, a wide area network, a campus area network, a metropolitan area network, an extranet, a private extranet, any set of two or more coupled electronic devices, or a combination of any of these or other appropriate networks.

Each of the logical or functional modules described above may comprise multiple modules. The modules may be implemented individually or their functions may be combined with the functions of other modules. Further, each of the modules may be implemented on individual components, or the modules may be implemented as a combination of components. For example, harvesting module 110, feature extracting module 120, clustering module 130, ranking module 140, display module 150, and/or electronic information modules 151 or 152 may each be implemented by a field-programmable gate array (FPGA), an application-specific integrated circuit (ASIC), a complex programmable logic device (CPLD), a printed circuit board (PCB), a combination of programmable logic components and programmable interconnects, single central processing unit (CPU) chip, a CPU chip combined on a motherboard, a general purpose computer, or any other combination of devices or modules capable of performing the tasks of modules 110, 120, 130, 140, 150, 151, and/or 152. Storage associated with any of the modules 110, 120, 130, 140, 150, 151, and/or 152 may comprise a random access memory (RAM), a read only memory (ROM), a programmable read-only memory (PROM), a field programmable read-only memory (FPROM), or other dynamic storage device for storing information and instructions to be used by modules 110, 120, 130, 140, 150, 151, and/or 152. Storage associated with a module may also include a database, one or more computer files in a directory structure, or any other appropriate data storage mechanism.

Other embodiments of the claimed inventions will be apparent to those skilled in the art from consideration of the specification and practice of the inventions disclosed herein. It is intended that the specification and examples be considered as exemplary only, with a true scope and spirit of the inventions being indicated by the following claims.

What is claimed is:

1. A method for identifying information about a particular entity comprising:
receiving electronic documents selected based on one or more search terms from a plurality of terms related to the particular entity;
determining one or more feature vectors for each received electronic document, wherein each feature vector is determined based on the associated electronic document;
clustering the received electronic documents into a first set of clusters of documents based on the similarity among the determined feature vectors; and
determining a rank for each cluster of documents in the first set of clusters of documents based on one or more ranking terms from the plurality of terms related to the particular entity, wherein the one or more ranking terms contain at least one term from the plurality of terms for the particular entity that is not in the one or more search terms.

2. The method of claim 1, wherein the one or more feature vectors comprise one or more feature vectors from the group selected from a term frequency inverse document frequency vector, a proper noun vector, a metadata vector, and a personal information vector.

3. The method of claim 1, further comprising presenting the ranked clusters to the particular entity.

4. The method of claim 1, further comprising:
reviewing the ranked clusters;
modifying the ranking of the clusters; and
presenting the modified ranking of the clusters to the particular entity.

5. The method of claim 4, wherein modifying the ranking of the clusters comprises removing or combining one or more clusters from the results.

6. The method of claim 1, further comprising:
determining a second set of one or more search terms based on one or more features in the determined feature vectors of one or more received electronic documents;
receiving a second set of electronic documents selected based on the second set of one or search terms;
determining a second set of one or more feature vectors for each electronic document in the second set of electronic documents, wherein each feature vector is determined based on the associated electronic document;
clustering the second set of received electronic documents into a second set of clusters of documents based on the similarity among the second set of one or more feature vectors; and
determining a rank for each cluster of documents in the first set of clusters of documents and the second set of clustered documents based on the one or more ranking terms from the plurality of terms related to the particular entity, wherein the one or more ranking terms contains at least one term from the plurality of terms for the particular entity that is not in the second set of one or more search terms.

7. The method of claim 6, wherein the second set of one or more search terms are determined based on the frequency of occurrence of those features in the one or more feature vectors that do not have a corresponding term in the plurality of terms related to the particular entity.

8. The method of claim 1, further comprising:
submitting a query to an electronic information module, wherein the query is determined based on the one or more search terms; and
receiving the electronic documents comprises receiving a response to the query from the electronic information module.

9. The method of claim 1, further comprising:
receiving a set of electronic documents, wherein the set of electronic documents are selected based on a first set of one or more search terms from the plurality of terms related to the particular entity;
if the set of electronic documents contains more than a threshold number of electronic documents, then determining the one or more search terms used in the receiving step as the first set of one or more search terms combined with a second set of one or more search terms from the plurality of terms related to the particular entity, wherein the search terms in the second set of one or more search terms and the search terms in the first set of one or more search terms do not overlap; and
if the set of electronic documents contains no more than the threshold number of electronic documents, then the step of receiving the electronic documents comprises receiving the set of electronic documents.

10. The method of claim 1, further comprising:
receiving a set of electronic documents, wherein the set of electronic documents are selected based on a first set of one or more search terms from the plurality of terms related to the particular entity;
determining a count of direct pages in the first set of electronic documents;
if the set of electronic documents contains more than a threshold count of direct pages, then determining the one or more search terms used in the receiving step as the first set of one or more search terms in combination with a second set of one or more search terms from the plurality of terms related to the particular entity, wherein the features in the second set of one or more search terms and the features in the first set of one or more search terms do not overlap; and
if the set of electronic documents contains no more than the threshold count of direct pages, then the step of receiving the electronic documents comprises receiving the set of electronic documents.

11. The method of claim 1, wherein clustering the received electronic documents comprises:
(a) creating initial clusters of documents;
(b) for each cluster of documents, determining the similarity of the feature vectors of the documents within each cluster with those in each other cluster;
(c) determining a highest similarity measure among all of the clusters; and
(d) if the highest similarity measure is at least a threshold value, combining the two clusters with the highest determined similarity measure.

12. The method of claim 11, wherein clustering the received electronic documents further comprises repeating steps (b), (c), and (d) until the highest similarity measure among the clusters is below the threshold value.

13. The method of claim 11, wherein the similarity of the feature vectors of a document is calculated based on a normalized dot product of the feature vectors.

14. The method of claim 1, wherein determining the rank for each cluster of documents comprises assigning a higher rank to those clusters of documents that contain documents that have a higher similarity measure with the one or more ranking terms.

15. A system for identifying information about a particular entity comprising:
a harvesting module configured to receive electronic documents selected based on one or more search terms from a plurality of terms related to the particular entity;
a feature extracting module configured to determine one or more feature vectors associated with each received electronic document, wherein each feature vector is determined based on the associated electronic document;
a clustering module configured to cluster the received electronic documents into a first set of clusters of documents based on the similarity among the determined feature vectors; and
a ranking module configured to determine a rank for each cluster of documents in the first set of clusters of documents based on one or more ranking terms from the plurality of terms related to the particular entity, wherein the one or more ranking terms contain at least one term from the plurality of terms for the particular entity that is not in the one or more search terms.

16. The system of claim 15, wherein the feature extracting module is further configured to determine the one or more feature vectors from the group selected from a term frequency inverse document frequency vector, a proper noun vector, a metadata vector, and a personal information vector.

17. The system of claim 15, further comprising a display module configured to present the ranked clusters to the particular entity.

18. The system of claim 15, wherein:
the harvesting module is further configured to receive a second set of electronic documents selected based on a second set of one or more search terms wherein the second set of search terms is determined based on one or more features in the determined feature vectors of one or more received electronic documents;
the feature extracting module is further configured to determine a second set of one or more feature vectors for each electronic document in the second set of electronic documents, wherein each feature vector is determined based on the associated electronic document;
the clustering module is further configured to cluster the second set of received electronic documents into a second set of clusters of documents based on the similarity among the second set of one or more feature vectors; and
the ranking module is configured to determine a rank for each cluster of documents in the first set of clusters of documents and the second set of clustered documents based on the one or more ranking terms from the plurality of terms related to the particular entity, wherein the one or more ranking terms contains at least one term from the plurality of terms for the particular entity that is not in the second set of one or more search terms.

19. The system of claim 20, wherein the harvesting module is further configured to determine the second set of one or more search terms based on the frequency of occurrence of those features in the one or more feature vectors that do not have a corresponding term in the plurality of terms related to the particular entity.

20. The system of claim 15, wherein the harvesting module is further configured to:
submit a query to an electronic information module, wherein the query is determined based on the one or more search terms; and
receive the electronic documents via a response to the query from the electronic information module.

21. The system of claim 15, wherein the harvesting module is configured to:
select a set of electronic documents based on a first set of one or more search terms from the plurality of terms related to the particular entity; and
determine whether the set of electronic documents contains more than a threshold number of electronic documents.

22. The system of claim 21, wherein the harvesting module is further configured to refine the selection, if the first set of electronic documents contains more than the threshold number of electronic documents, by determining the one or more search terms used to select the set of electronic documents as the first set of one or more search terms combined with a second set of one or more search terms from the plurality of terms related to the particular entity, wherein the search terms in the second set of one or more search terms and the search terms in the first set of one or more search terms do not overlap.

23. The system of claim 21, wherein the harvesting module is further configured to receive the set of electronic documents if the set of electronic documents contains no more than the threshold number of electronic documents.

24. The system of claim 15, wherein the harvesting module is configured to:
select a set of electronic documents based on a first set of one or more search terms from the plurality of terms related to the particular entity; and
determine a count of direct pages in the set of electronic documents.

25. The system of claim 24, wherein the harvesting module is further configured to refine the selection, if the count of direct pages in the set of electronic documents contains more than a threshold count of direct pages, by determining the one or more search terms used to select the set of electronic documents as the first set of one or more search terms in combination with a second set of one or more search terms from the plurality of terms related to the particular entity, wherein the features in the second set of one or more search terms and the features in the first set of one or more search terms do not overlap.

26. The system of claim 24, wherein the harvesting module is further configured to receive the set of electronic documents if the set of electronic documents contains no more than the threshold count of direct pages.

27. The system of claim 15, wherein the clustering module is further configured to:
(a) create initial clusters of documents;
(b) determine the similarity of the feature vectors of the documents within each cluster with those in each other cluster for each cluster of documents;
(c) determine a highest similarity measure among all of the clusters; and
(d) combine the two clusters with the highest determined similarity measure if the highest similarity measure is at least a threshold value.

28. The system of claim 27, wherein the clustering module is further configured to repeat steps (b), (c), and (d) until the highest similarity measure among the clusters is below the threshold value.

29. The system of claim 27, wherein the feature extracting module is further configured to calculate the similarity of the feature vectors of a document based on a normalized dot product of the feature vectors.

30. The system of claim 15, wherein the ranking module is configured to determine the rank for each cluster of documents by assigning a higher rank to those clusters of documents that contain documents that have a higher similarity measure with the one or more ranking terms.

31. A computer readable medium including instructions that, when executed, cause a computer to perform a method for identifying information about a particular entity, the method comprising:
receiving electronic documents selected based on one or more search terms from a plurality of terms related to the particular entity;
determining one or more feature vectors for each received electronic document, wherein each feature vector is determined based on the associated electronic document;
clustering the received electronic documents into a first set of clusters of documents based on the similarity among the determined feature vectors; and
determining a rank for each cluster of documents in the first set of clusters of documents based on one or more ranking terms from the plurality of terms related to the particular entity, wherein the one or more ranking terms contain at least one term from the plurality of terms for the particular entity that is not in the one or more search terms.

32. The computer readable medium of claim 31, wherein the one or more feature vectors comprise one or more feature vectors from the group selected from a term frequency inverse document frequency vector, a proper noun vector, a metadata vector, and a personal information vector.

33. The computer readable medium of claim 31, further comprising presenting the ranked clusters to the particular entity.

34. The computer readable medium of claim 31, further comprising
reviewing the ranked clusters;
modifying the ranking of the clusters; and
presenting the modified ranking of the clusters to the particular entity.

35. The computer readable medium of claim 34, wherein modifying the ranking of the clusters comprises combining or removing one or more clusters from the results.

36. The computer readable medium of claim 31, further comprising:
determining a second set of one or more search terms based on one or more features in the determined feature vectors of one or more received electronic documents;
receiving a second set of electronic documents selected based on the second set of one or search terms;
determining a second set of one or more feature vectors for each electronic document in the second set of electronic documents, wherein each feature vector is determined based on the associated electronic document;
clustering the second set of received electronic documents into a second set of clusters of documents based on the similarity among the second set of one or more feature vectors; and
determining a rank for each cluster of documents in the first set of clusters of documents and the second set of clustered documents based on the one or more ranking terms from the plurality of terms related to the particular entity, wherein the one or more ranking terms contains at least one term from the plurality of terms for the particular entity that is not in the second set of one or more search terms.

37. The computer readable medium of claim 36, wherein the second set of one or more search terms are determined based on the frequency of occurrence of those features in the one or more feature vectors that do not have a corresponding term in the plurality of terms related to the particular entity.

38. The computer readable medium of claim 31, further comprising:
submitting a query to an electronic information module, wherein the query is determined based on the one or more search terms; and
receiving the electronic documents comprises receiving a response to the query from the electronic information module.

39. The computer readable medium of claim 31, further comprising:
receiving a set of electronic documents, wherein the set of electronic documents are selected based on a first set of one or more search terms from the plurality of terms related to the particular entity;
if the set of electronic documents contains more than a threshold number of electronic documents, then determining the one or more search terms used in the receiving step as the first set of one or more search terms combined with a second set of one or more search terms from the plurality of terms related to the particular entity, wherein the search terms in the second set of one or more search terms and the search terms in the first set of one or more search terms do not overlap; and
if the set of electronic documents contains no more than the threshold number of electronic documents, then step of receiving the electronic documents comprises receiving the set of electronic documents.

40. The computer readable medium of claim 31, further comprising:
receiving a set of electronic documents, wherein the set of electronic documents are selected based on a first set of one or more search terms from the plurality of terms related to the particular entity;
determining a count of direct pages in the set of electronic documents;
if the set of electronic documents contains more than a threshold count of direct pages, then determining the one or more search terms used in the receiving step as the first set of one or more search terms in combination with a second set of one or more search terms from the plurality of terms related to the particular entity, wherein the features in the second set of one or more search terms and the features in the first set of one or more search terms do not overlap; and
if the set of electronic documents contains no more than the threshold count of direct pages, then step of receiving the electronic documents comprises receiving the set of electronic documents.

41. The computer readable medium of claim 31, wherein clustering the received electronic documents comprises:
(a) creating initial clusters of documents;
(b) for each cluster of documents, determining the similarity of the feature vectors of the documents within each cluster with those in each other cluster;
(c) determining a highest similarity measure among all of the clusters; and
(d) if the highest similarity measure is at least a threshold value, combining the two clusters with the highest determined similarity measure.

42. The computer readable medium of claim 41, wherein clustering the received electronic documents further comprises repeating steps (b), (c), and (d) until the highest similarity measure among the clusters is below the threshold value.

43. The computer readable medium of claim 41, wherein the similarity of the feature vectors of a document is calculated based on a normalized dot product of the feature vectors.

44. The computer readable medium of claim 31, wherein determining the rank for each cluster of documents comprises assigning a higher rank to those clusters of documents that contain documents that have a higher similarity measure with the one or more ranking terms.

45. An apparatus for identifying information about a particular entity comprising:
means for receiving electronic documents selected based on one or more search terms from a plurality of terms related to the particular entity;
means for determining one or more feature vectors for each received electronic document, wherein each feature vector is determined based on the associated electronic document;
means for clustering the received electronic documents into a first set of clusters of documents based on the similarity among the determined feature vectors; and
means for determining a rank for each cluster of documents in the first set of clusters of documents based on one or more ranking terms from the plurality of terms related to the particular entity, wherein the one or more ranking terms contain at least one term from the plurality of terms for the particular entity that is not in the one or more search terms.
